(19) United States
(12) Patent Application Publication
(10) Pub. No.: US 2006/0009265 A1
(43) Pub. Date: Jan. 12, 2006

(54) Communication blackout feature

(76) Inventor: Edward O. Clapper, Tempe, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/882,928

(22) Filed: Jun. 30, 2004

(51) Int. Cl. H04B 1/38

(52) U.S. Cl. 455/565

(57) ABSTRACT

A method and apparatus for a communication blackout feature. An embodiment of a method comprises receiving a blackout request for a communication device; enabling a blackout mode for the communication device; modifying a signal for incoming calls or messages while the blackout mode is enabled; and at the end of a time period, automatically deactivating the blackout mode.

### FIELD

An embodiment of the invention relates to communications in general, and more specifically to an automated system management process.

### BACKGROUND

Communications devices such as telephones, personal digital assistants (PDAs), and similar devices have enabled individuals become more and more connected with others. In the work environment, it is now possible to remain relatively accessible at all times.

Such accessibility has come at a price. In many business and social environments, interruptions from communications devices are unwelcome or inappropriate. For example, an individual may prefer not to receive calls or messages during a business meeting, a meal at a fine restaurant, a concert or play, or a religious service. For this reason, it is often necessary to turn off or silence communications devices.

However, the need to cut off communications may cause difficulties. In using, for example, a conventional cellular telephone, it may be possible to turn off all ringing signals, but the user then is required to remember to reactivate the device. If a user turns off a telephone during a meeting, the telephone may remain off for an extended period after the meeting, and thus the user risks missing numerous important calls after the end of the meeting.

### BRIEF DESCRIPTION OF THE DRAWINGS

The invention may be best understood by referring to the following description and accompanying drawings that are used to illustrate embodiments of the invention. In the drawings:

FIG. 1 is a flow chart to illustrate an embodiment of a process for utilizing a blackout feature in a communications device;

FIG. 2 is a flow chart to illustrate an embodiment of a process for processing calls with a blackout mode;

FIG. 3 illustrates an embodiment of a menu for choosing a blackout mode;

FIG. 4 illustrates an embodiment of a menu for choosing elements of a blackout mode; and

FIG. 5 is an illustration of an embodiment of a communication device.

### DETAILED DESCRIPTION

A method and apparatus are described for a communication blackout feature.

According to an embodiment of the invention, a communication device includes a blackout feature. In an embodiment, a communication device ceases or modifies signals such as ringing that are used to signal incoming messages, calls, or other communications for a time period, and then the communication device automatically returns to a normal or preexisting mode at the end of the time period.

Under an embodiment of the invention, a communication device can be any device that is utilized for communications and that provides a signal to a user of the device. The communication device can include a telephone, such as a cellular telephone; a PDA or computer with communications functions; a text-messaging device; or other similar device. A signal from a communications device may include a ringing signal or other auditory signal; a vibration or other tactile signal; or flashing lights or other visual signal.

Under an embodiment of the invention, a user of a communications device makes a request or command for a blackout period. The communication device may set the blackout period for a predetermined length of time, or may allow the user to enter a blackout period length.

In an embodiment of the invention, a user may make a request for a blackout period by various methods. For example, a user may make a request by pressing a button, entering a request or command in a menu, making a audible command, or any other command method. The request may include details regarding the blackout period, such as what kind of signal, if any, is provided during the blackout period.

Under an embodiment of the invention, a user may designate a time period or an ending time for a blackout period. In one example, a blackout period may end forty-five minutes after the period is commenced. In a second example, a blackout period may end at a particular time, such as at noon.

Under an embodiment of the invention, a communication device includes an automatic return to normal operation at the end of a blackout period. In an embodiment, the communication devices has enabled a blackout period, the blackout period is deactivated automatically at the end of the blackout period without any further action required by a user of the device. For example, if a cellular telephone is placed into a blackout mode for a sixty-minute period, the telephone returns to its normal or preexisting signaling mode at the conclusion of the sixty-minute period and thus the telephone will provide normal signaling for incoming calls, messages, or other communications.

During a blackout period, an embodiment of a communication device may silence or disable all signals, including any ringing signals, vibrations, or lights that may signify an incoming call, text message, or other communication. Under another embodiment, a communications device may allow a user to choose a less obtrusive signal during a blackout period. For example, a telephone that normally uses an audible ringing signal to signify an incoming call may provide a vibration during the blackout period, or may utilize a visual signal, or may provide an audible signal with low volume and duration.

Under an embodiment of the invention, instead of transitioning directly from a blackout period to a normal mode, a communication device may proceed through a staged return in which the device changes to a secondary mode for a time period before returning to normal signaling operation. In an embodiment, the communication device may provide a relatively quiet or otherwise unobtrusive signal during the secondary mode. In one possible example, a communication device may have a blackout period for one hour. During the first forty-five minutes of the blackout period, the communication device provides no signals when a message or call is received. During the last fifteen minutes of the blackout period, the communication device may provide a relatively unobtrusive signal (such as a short vibration) when an incoming message or call is received. With a staged return to normal mode, a user may institute a blackout period that is long enough to proceed through an event without interruption, but that still provides some signals at the end of the period to reduce the likelihood that messages or calls will be missed. Other embodiments of the invention may provide staged periods that come at different points during the blackout period, or in which there are multiple stages. In another example, a cellular phone may be set to vibrate during the beginning of a blackout period, rather than the end, if, for example, a call is expected during the beginning of the period, or if there is less likelihood of interrupting others during the beginning of the blackout period.

In one embodiment of the invention, a user may schedule a blackout period ahead of time. For example, a user may be aware that an upcoming event requires a blackout period. The user may request both a beginning time and a blackout period length, or a beginning time and end time, for the blackout period. In this way, the user is not required to remember either to commence the blackout period or to end the blackout period as the period is entered automatically and ends automatically. In one embodiment, a blackout feature of a communication device operates in conjunction with a calendar feature, the calendar feature being part of the communication device or being a part of another device or service. For example, a user may schedule a meeting in a calendar. The entry of the meeting may optionally create a request or command for a blackout period for a communication device. In one example, a communications enabled PDA may include a calendar function. When entering appointments in the calendar, the PDA may calendar blackout periods for the appointments, during which signals for incoming messages or calls are silenced. In another example, a user may enter appointments into a computer calendar. The computer calendar may provide a signal, such as by Bluetooth communications or other system, to the telephone requesting or commanding that the telephone schedule a blackout period during certain appointments.

Under an embodiment of the invention, a blackout period may be requested for certain repeating time periods. In one example, a communication device may enable a blackout period every night between certain hours so that the device can be left on without disturbing the user at night. In another example, a communication device may enable a blackout period once week during certain times so that a regularly scheduled meeting, event, or service is uninterrupted without any additional action on the part of the user of the communication device.

Under an embodiment of the invention, a communications device may provide an end of mode warning signal to warn the operator of the device that a blackout period is nearing its end. In one embodiment, a communications device may provide a short vibration or noise (such as a short “chirping” signal) to warn the user that there are, for example, five minutes left in the blackout period. The operator of the communication device may then have the option of, for example, extending the blackout period. In one possible example, the user of a cellular telephone may place the telephone in a blackout period for a ninety-minute period for a meeting. When there are five minutes left in the blackout period, a short audible signal is generated to inform the user that the end of the blackout period is approaching. If the meeting has not ended, the user may then, for example, extend the blackout for an additional time period (such as for another fifteen minutes) by pressing a button on the communication device.

Under an embodiment of the invention, a communication device may provide a signal to the user to inform the user that a blackout period has ended. In another embodiment, at the end of a blackout period the communication device may inform the user whether or not any signals were silenced during the blackout period. For example, after a blackout period has ended, the communication device may provide a first signal to inform the user that no messages or calls were received during the blackout period and a second signal to inform the user that one or more incoming calls or messages were received during the blackout period.

In an embodiment of the invention, a communication device includes a processor that, among other possible functions, processes any blackout period. In one embodiment, the processor includes blackout functionality in the logic of the processor. In another embodiment, blackout functionality is provided in instructions that are stored in some medium, such as in a ROM (read-only memory) or non-volatile memory, such as flash memory. The processor includes an execution unit for the processing of instructions regarding blackout functions.

Under one embodiment of the invention, a person other than the user may make the request for a blackout period for a communication device. In one possible example, all communications devices in a certain area may receive requests from a system for a blackout period. Each communications device in the area that accepts the request is placed in a blackout mode. For example, a concert hall may contain a device to transmit a request to all telephones in the concert hall for a blackout period, with the period being a time period sufficient for the length of a concert. If the requests are accepted, the communication devices are silenced for the length of the concert and then return to normal signaling operation at the end of the time period.

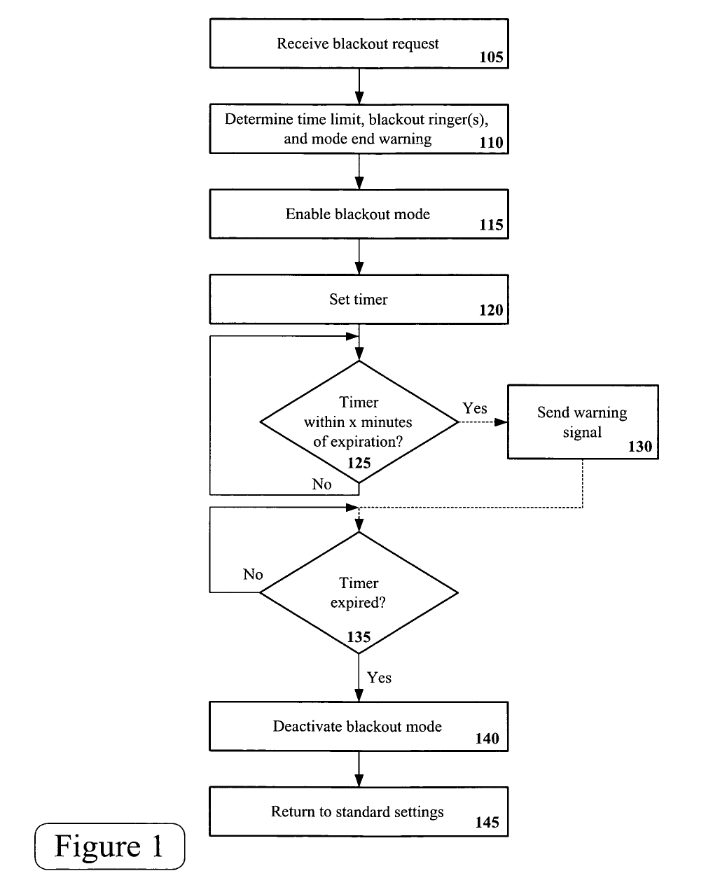

FIG. 1 is a flow chart to illustrate an embodiment of a process for utilizing a blackout feature in a communications device. In this illustration, a communication device receives a request for a blackout period 105. The blackout request may be made by pushing a button on a telephone, by making a selection on a menu of a computer or other device, by entering an appointment on a calendar, or by any other method. In an embodiment, details regarding the blackout period may be obtained, such as the time limit or set times for the blackout period; the signals to be provided during the blackout period, if any; and the warning for the end of the blackout period 110. The blackout period is then enabled 115, and a timer is set 120 or the time until the end of the period is otherwise measured. In an embodiment, when the timer reaches x minutes from the end of the blackout period 125, then a warning signal is sent 130, which may allow the user to extend the blackout period. When the timer then expires 135, the blackout mode is deactivated automatically 140 and the communication device returns to a normal, standard, or preexisting mode 145.

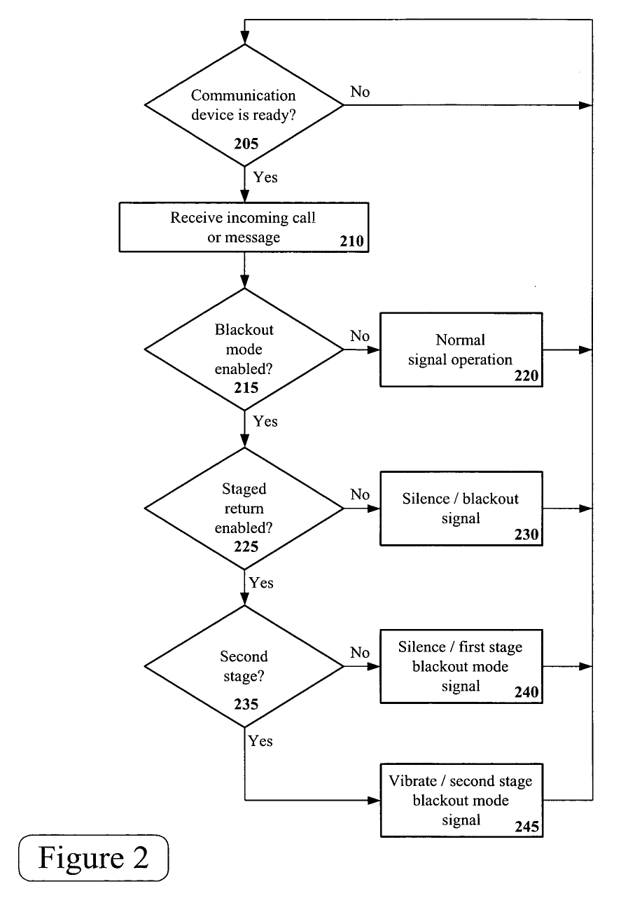

FIG. 2 is a flow chart to illustrate an embodiment of a process for processing calls with a blackout mode. In this illustration, if a communication device is ready 205, such as when a cellular telephone is on and currently unconnected, an incoming call may be received 210. If a blackout mode is not currently enabled 215, then normal ring operations are used 220. If a blackout mode is currently enabled 215, but a staged return is not enabled 225, then the communication signal for the communication device is silenced or any other blackout signal is generated 220. If a staged return is enabled 225, and the device is not in a secondary stage 235, then the signal is silenced or other first stage blackout signal is generated 240. If the device is in a secondary stage 235, then a vibration or other secondary stage signal is generated 245.

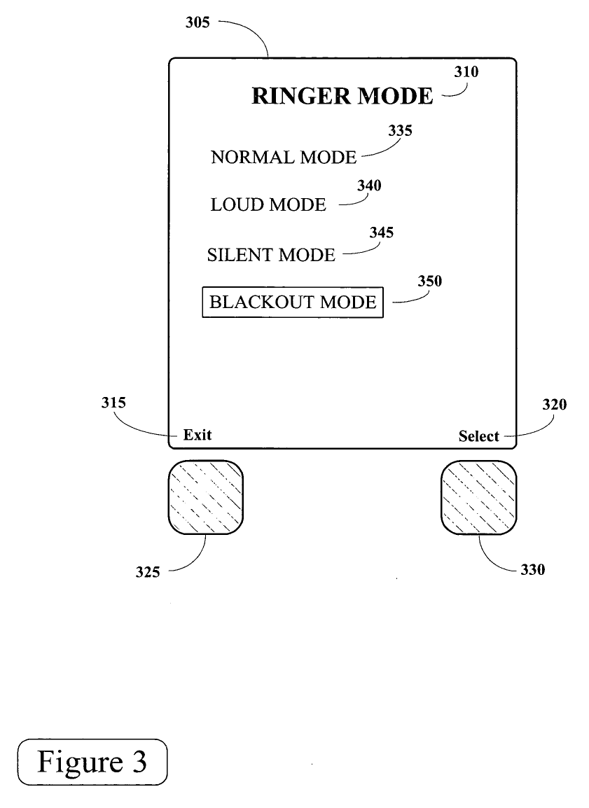

FIG. 3 illustrates an embodiment of a menu for choosing a blackout mode. In this illustration a cellular phone or other communication device may have a display screen 305 to be used to display a ringer mode menu 310. A user of the device may exit a menu 315 or make a selection in the menu 320. A choice may be made by, for example, pressing a button, such as a first soft key 325 or a second soft key 330, with the keys being described as soft because the commands made will vary depending on the circumstances. In this particular example, the display screen 315 has various different ring modes, including a normal mode 335, a loud mode 340 in which the volume of the ringer is increased, a silent mode 345 in which the ringer is silenced until the mode is deactivated, and a blackout mode 350. In the blackout mode, the device remains in the blackout mode until a time period expires, and then the device is automatically returned to a normal signaling mode or to the mode existing at the beginning of the blackout period.

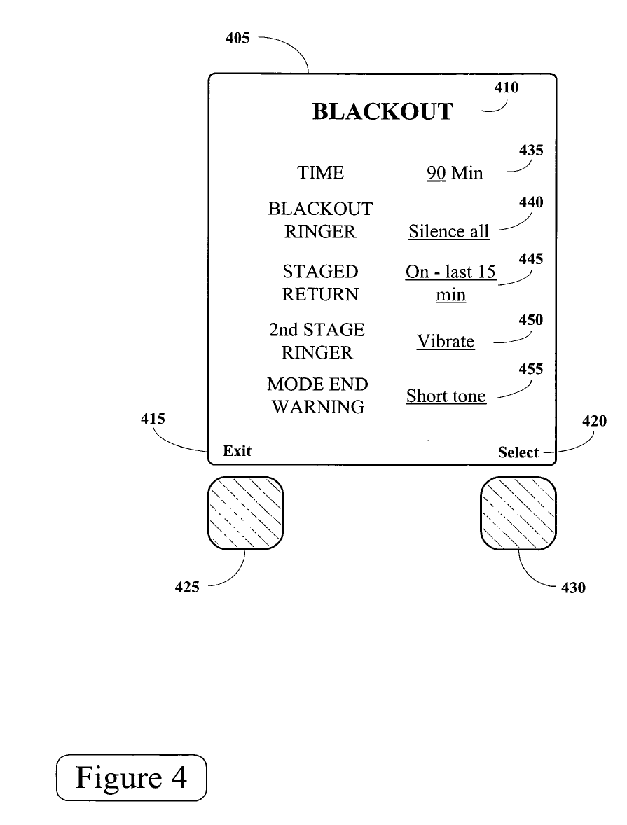

FIG. 4 illustrates an embodiment of a menu for choosing elements of a blackout mode. In this illustration a cellular phone or other communication device may have a display screen 405 to be used to display a blackout menu 410. A user of the device may exit a menu 415 or make a selection in the menu 420. A choice may be made by, for example, pressing a button, such as a first soft key 425 or a second soft key 430. In this particular example, the display screen 415 has various options for a blackout period. For example, a user may enter a time period for the blackout period 435; a blackout ring mode, such as to silence all signals 440; whether the device returns to normal operations in stages 445 and what signal is to be used in a secondary mode 450; and what signal is used to warn the user regarding an impending end to the blackout mode 455.

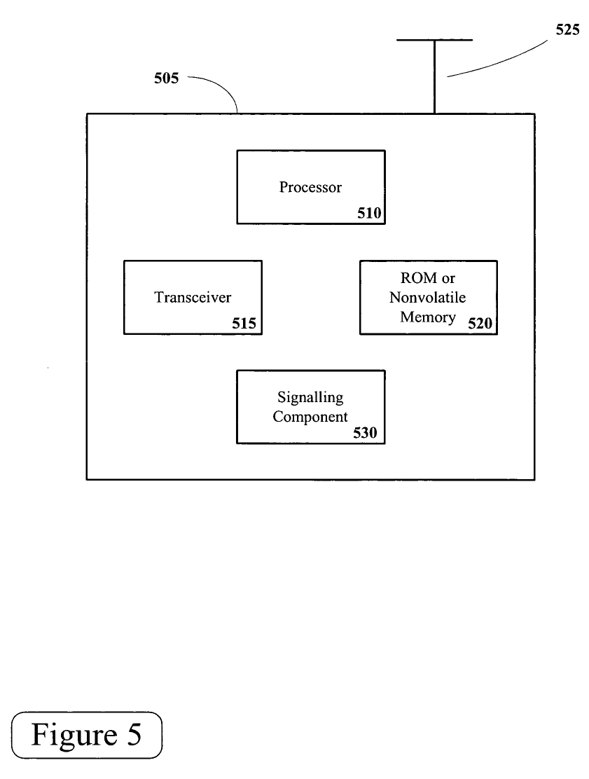

FIG. 5 is an illustration of an embodiment of a communication device. Embodiments of the invention may be implemented in many types of devices. In one example, a communication device 505 is a cellular telephone or other wireless communication device. The communication device 505 includes a processor 510 that processes operations for blackout periods. In this illustration, the communication device further includes a transceiver 515 to send and receive communications, including any incoming messages or calls. The communication device 505 may include a ROM or nonvolatile memory 520 or other type of memory. In one embodiment, the processor 510 includes blackout functionality. In another embodiment, commands for the blackout functionality are stored in the ROM or nonvolatile memory 520. The communication device may further include an antenna 525, through which the communication device 505 may send and receive communications. Under an embodiment, the communication device 505 includes a signaling component 505 to provide a signal to a user of the communication device 505. In an embodiment, the signaling component 530 may include a speaker to provide an audible signal, a vibration unit to provide a tactile signal, or a light to provide a visual signal. Under an embodiment of the invention, the communication device 505 disables or modifies the operation of the signaling component 530 during a blackout period. In one example, the signaling component 530 transitions from a normal mode to an inactive mode at the beginning of a blackout period, and then transitions from the inactive mode to the normal mode at the end of the blackout period.

In the description provided above, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form.

The present invention may include various processes. The processes of the present invention may be performed by hardware components or may be embodied in machine-executable instructions, which may be used to cause a general-purpose or special-purpose processor or logic circuits programmed with the instructions to perform the processes. Alternatively, the processes may be performed by a combination of hardware and software.

Portions of the present invention may be provided as a computer program product, which may include a machine-readable medium having stored thereon instructions, which may be used to program a computer (or other electronic devices) to perform a process according to the present invention. The machine-readable medium may include, but is not limited to, floppy diskettes, optical disks, CD-ROMs (compact disk read-only memory), and magneto-optical disks, ROMs (read-only memory), RAMs (random access memory), EPROMs (erasable programmable read-only memory), EEPROMs (electrically-erasable programmable read-only memory), magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem or network connection).

Many of the methods are described in their most basic form, but processes may be added to or deleted from any of the methods and information may be added or subtracted from any of the described messages without departing from the basic scope of the present invention. It will be apparent to those skilled in the art that many further modifications and adaptations may be made. The particular embodiments are not provided to limit the invention but to illustrate it. The scope of the present invention is not to be determined by the specific examples provided above but only by the claims below.

It should also be appreciated that reference throughout this specification to “one embodiment” or “an embodiment” means that a particular feature may be included in the practice of the invention. Similarly, it should be appreciated that in the foregoing description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. A method comprising:
receiving a blackout request for a communication device;
enabling a blackout mode for the communication device;
modifying a signal for incoming calls or messages while the blackout mode is enabled; and
at the end of a time period, automatically deactivating the blackout mode.

2. The method of claim 1, wherein the signal for incoming calls or messages is discontinued while the blackout mode is enabled.

3. The method of claim 1, further comprising generating a warning signal when the end of the blackout mode will occur within a certain amount of time.

4. The method of claim 1, further comprising receiving a request for an extension of the blackout mode and extending the time period for the blackout mode in response to the request for extension.

5. The method of claim 1, further comprising generating a signal at the end of the blackout mode.

6. The method of claim 1, wherein the blackout mode includes a first blackout period and a second blackout period, and further comprising automatically transitioning from the first blackout period to the second blackout period at a particular time.

7. The method of claim 6, further comprising modifying the signal for incoming calls or messages in a first manner during the first blackout period and in a second manner during the second blackout period.

8. The method of claim 1, wherein the request for the blackout period requests a recurring blackout period.

9. A processor comprising:
an execution unit; and
instructions for the execution unit to provide a communication blackout feature;
the communication blackout feature comprising:
beginning a blackout period for incoming communications,
during the blackout period, modifying a signal for an incoming communication, and
automatically ending the blackout period.

10. The processor of claim 9, wherein modifying the signal for the incoming communication comprising discontinuing the signal while the blackout period is active.

11. The processor of claim 9, wherein the processor is to be used in a communication device.

12. The processor of claim 11, wherein the communication device is a cellular telephone.

13. The processor of claim 9, wherein the blackout feature further comprises generating a signal for a warning when the end of the blackout period will occur within a certain time period.

14. The processor of claim 9, wherein the blackout feature further comprises extending the blackout period on request.

15. The processor of claim 9, wherein the blackout feature further comprises generating a signal to signify the end of the blackout period.

16. A communication device comprising: <
a processor, the processor to provide a blackout function, the blackout function to provide a blackout period that is automatically deactivated at the end of a time period;
a component to receive incoming communications for the communication device; and
a signaling component to provide a signal when a communication is received, the operation of the signaling component to be modified by the processor during the blackout period.

17. The communication device of claim 16, wherein the component to receive incoming communications comprises a transceiver.

18. The communication device of claim 16, wherein the communication device comprises a cellular telephone.

19. The communication device of claim 16, further comprising a menu function, the menu function including a request for a blackout period.

20. The communication device of claim 16, further comprising a calendar function, the calendar function including a request for a blackout period.

21. A machine-readable medium having stored thereon data representing sequences of instructions that, when executed by a processor, cause the processor to perform operations comprising:
receiving a blackout request for a communication device;
enabling a blackout mode for the communication device;
modifying a signal for incoming calls or messages while the blackout mode is enabled; and
at the end of a time period, automatically deactivating the blackout mode.

22. The medium of claim 21, wherein the signal for incoming calls or messages is discontinued while the blackout mode is enabled.

23. The medium of claim 21, further comprising instructions that, when executed by the processor, cause the processor to perform operations comprising generating a warning signal when the end of the blackout mode will occur within a certain amount of time.

24. The medium of claim 21, further comprising instructions that, when executed by the processor, cause the processor to perform operations comprising receiving a request for an extension of the blackout mode and extending the time period for the blackout mode in response to the request for extension.

25. The medium of claim 21, further comprising instructions that, when executed by the processor, cause the processor to perform operations comprising generating a signal at the end of the blackout mode.

26. The medium of claim 21, wherein the blackout mode includes a first blackout period and a second blackout period, and further comprising automatically transitioning from the first blackout period to the second blackout period at a particular time.

27. The medium of claim 26, further comprising instructions that, when executed by the processor, cause the processor to perform operations comprising modifying the signal for incoming calls or messages in a first manner during the first blackout period and in a second manner during the second blackout period.

28. The medium of claim 21, wherein the request for the blackout period requests a recurring blackout period.
